(19) United States
(12) Patent Application Publication
(10) Pub. No.: US 2013/0103607 A1
(43) Pub. Date: Apr. 25, 2013

(54) Determination of Projected Carrier Assignment

(71) Applicants: Ivory W. Knipfer, Rochester, MN (US); Carl C. Meier, Rochester, MN (US); Dale W. Petersilka, Eau Claire, WI (US); Matthew H. Zemke, Rochester, MN (US)

(72) Inventors: Ivory W. Knipfer, Rochester, MN (US); Carl C. Meier, Rochester, MN (US); Dale W. Petersilka, Eau Claire, WI (US); Matthew H. Zemke, Rochester, MN (US)

(73) Assignee: INTERNATIONAL BUSINESS MACHINES CORPORATION, Armonk, NY (US)

(21) Appl. No.: 13/277,943

(22) Filed: Oct. 20, 2011

(51) Int. Cl. G06Q 10/08

(52) U.S. Cl. 705/335; 705/334

(57) ABSTRACT

A computer implemented method, a data processing system, and a computer program product determine carrier selection based on variable volumetric weight and variable completion times. A product is identified for production. The product for production has a variable weight and a variable dimension based on components included in the product for production. A projected volumetric weight of the product for production is determined. A projected completion time of the product for production is determined. A projected carrier assignment of the product for production is then determined in response to determining the projected volumetric weight of the product for production and determining the projected completion time of the product for production.

### BACKGROUND

1. Field

The disclosure relates generally to a computer implemented method, a data processing system, and a computer program product for assigning shipping carriers according to negotiated carrier contracts. More specifically, the disclosure relates to a computer implemented method, a data processing system, and a computer program product for determining carrier selection based on variable volumetric weight and variable completion times.

2. Description of the Related Art

Carrier costs represent a significant expense in order fulfillment. Inefficient use of carriers, as well as significant deviation from negotiated carrier contracts often results in higher shipping costs. Any reduction in this expense translates directly into increased profit.

Most manufacturers negotiate quarterly or annual carrier contracts based on estimated volumetric load. However, business variables, such as order book changes, supply constraints, or technical production issues, impact the estimated volumetric load and leads to alterations in manufacturing output. The manufacturer's inability to accurately forecast the overall volumetric load, let alone on a per carrier basis, frequently yields surpluses or shortages in available shipping capacity. Both of these situations yield significant cost inefficiencies including wasted shipping capacity and expensive shipping capacity.

Negotiating carrier contracts based on estimated volumetric load is even more challenging to businesses with highly configurable products. With highly configurable products, the volumetric weight is not determined until a product is prepared for shipment. Furthermore, the highly configurable nature of the products often leads to wide variations in manufacturing cycle time.

Typically, carrier needs have been estimated by keeping a rolling monthly or weekly outlook that is generally based on average product configurations using average expected manufacturing times. This rolling outlook generally works well when there is low variability in product configurations, so the dimensional output is known to have consistent lot sizes and consistent packaging. Furthermore, the rolling outlook works well when the manufacturing output is steady in a first-in-first-out manner without interruptions in production for quality, order change, cancellations, or supply constraints.

However, rolling outlooks do not account for variation in product configurations that can result in variable product packaging, requiring more or fewer boxes based on each order configuration. Product packaging determines real volumetric output on which carrier contracts are often based. Furthermore, rolling outlooks do not account for expected cycle times on an order-by-order basis. An order-by-order basis is necessary when considering changes in individual order content, order quantity, or cycle time impacting when the product exits manufacturing. Thus, rolling outlooks typically result in wildly inaccurate forecasts resulting in late fluctuations for carrier capacity, late capacity demand that drives higher freight fees and penalties for unplanned capacity, and unused capacity which was reserved but subsequently paid for with no shipment.

Another possible alternative is to give the carriers actual volumetric weight at the time the product is packaged. This method ensures that the output considers all packaging and containers as they exit manufacturing. However, this process provides no advance warning that can be used to alter carrier capacity. Any carrier capacity adjustments would be frequent and last minute, driving higher freight fees and penalties. Thus, providing actual volumetric weight at the time the product is packaged is impractical when there is any significant variability in volumetric output by order content or by manufacturing cycle time.

### SUMMARY

According to one embodiment of the present invention, a computer implemented method is provided for determining a projected carrier assignment for a product for production. A product is identified for production. The product for production has a variable weight and a variable dimension based on components included in the product for production. A projected volumetric weight of the product for production is determined. A projected completion time of the product for production is determined. A projected carrier assignment of the product for production is then determined in response to determining the projected volumetric weight of the product for production and determining the projected completion time of the product for production. According to another embodiment of the present invention, a computer storage medium having computer usable instructions for determining a projected carrier assignment for a product for production encoded thereon is provided. The computer storage medium comprises instructions for identifying a product for production. The product for production has a variable weight and a variable dimension based on components included in the product for production. The computer storage medium comprises instructions for determining a projected volumetric weight of the product for production. The computer storage medium comprises instructions for determining a projected completion time of the product for production. The computer storage medium comprises instructions, responsive to determining the projected volumetric weight of the product for production and determining the projected completion time of the product for production, for determining a projected carrier assignment of the product for production.

According to another embodiment of the present invention, a data processing system is provided. The data processing system comprises a storage having computer usable instructions for determining a projected carrier assignment for a product for production encoded thereon, a bus connecting the storage to a processor, and a processor. The processor executes the computer usable instructions to identify the product for production. The product for production has a variable weight and a variable dimension based on components included in the product for production. The processor executes the computer usable instructions to determine a projected volumetric weight of the product for production. The processor executes the computer usable instructions to determine a projected completion time of the product for production. The processor executes the computer usable instructions, responsive to determining the projected volumetric weight of the product for production and determining the projected completion time of the product for production to determine a projected carrier assignment of the product for production.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is an illustration of a data processing system in accordance with an advantageous embodiment;

FIG. 3 is a high level data flow diagram for determining carrier selection based on variable volumetric weight and variable completion times in accordance with an illustrative embodiment;

FIG. 4 is a data flow for predicting volumetric weight during supply chain order fulfillment in accordance with an illustrative embodiment;

FIG. 5 is a data flow for predicting completion times during supply chain order fulfillment in accordance with an illustrative embodiment;

FIG. 6 is an exemplary activity/cycle time relationship table in accordance with an illustrative embodiment;

FIG. 7 is a data flow diagram for determining carrier selection based on variable volumetric weight and variable completion times in accordance with an illustrative embodiment;

FIG. 8 is a high level flow chart for determining carrier selection based on variable volumetric weight and variable completion times in accordance with an illustrative embodiment;

FIG. 9 is a flowchart for retrieving a carrier list in accordance with an illustrative embodiment;

FIG. 10 is a flowchart for retrieving carrier statistics in accordance with an illustrative embodiment;

FIG. 11 is a flowchart for projecting a carrier for an order in accordance with an illustrative embodiment;

FIG. 12 is a flowchart of a process for determining carrier compliance statistics in accordance with an illustrative embodiment;

FIG. 13 is a flowchart of a process for sending carrier forecasts to projected carriers in accordance with an illustrative embodiment; and

FIGS. 14A-14B are carrier assignment strategies in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

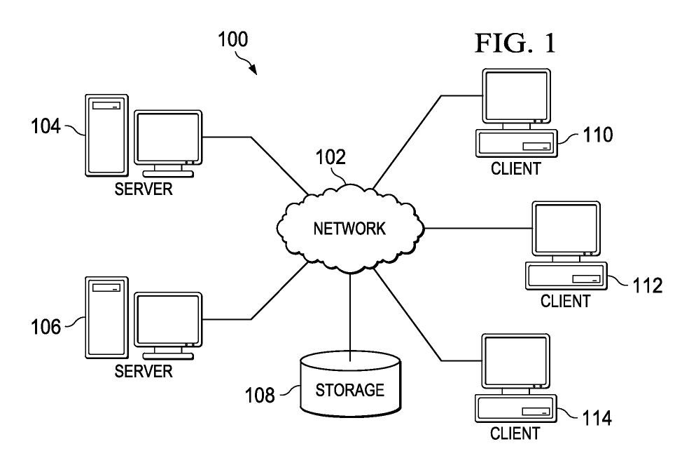

With reference now to the figures and, in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

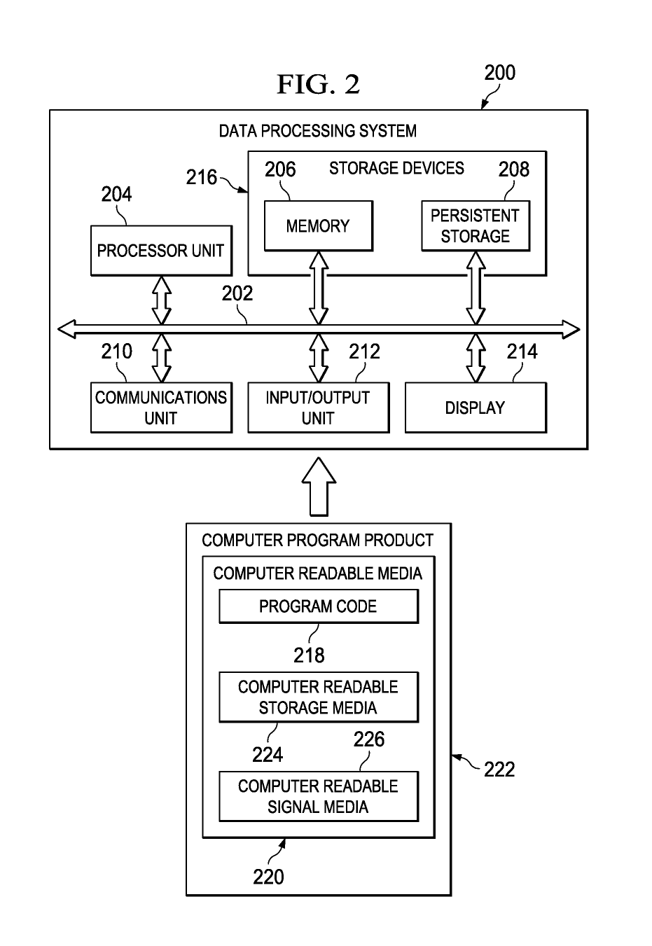

Turning now to FIG. 2, an illustration of a data processing system is depicted in accordance with an advantageous embodiment. In this illustrative example, data processing system 200 includes communications framework 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Storage devices 216 may also be referred to as computer readable storage devices in these examples. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications framework 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200. In these examples, computer readable storage media 224 is a physical or tangible storage device used to store program code 218 rather than a medium that propagates or transmits program code 218. Computer readable storage media 224 is also referred to as a computer readable tangible storage device or a computer readable physical storage device. In other words, computer readable storage media 224 is a media that can be touched by a person.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some advantageous embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different advantageous embodiments may be implemented in a data processing system including components in addition to or in place of those illustrated for data processing system 200. Other components shown in FIG. 2 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 204 may take the form of a hardware unit that has circuits that are manufactured or configured for a particular use. This type of hardware may perform operations without needing program code to be loaded into a memory from a storage device to be configured to perform the operations.

For example, when processor unit 204 takes the form of a hardware unit, processor unit 204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 218 may be omitted because the processes for the different embodiments are implemented in a hardware unit.

In still another illustrative example, processor unit 204 may be implemented using a combination of processors found in computers and hardware units. Processor unit 204 may have a number of hardware units and a number of processors that are configured to run program code 218. With this depicted example, some of the processes may be implemented in the number of hardware units, while other processes may be implemented in the number of processors.

In another example, a bus system may be used to implement communications framework 202 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of more devices that transmit data, receive data, or transmit and receive data. A communications unit may be, for example, a modem or a network adapter, two network adapters, or some combination thereof. Further, a memory may be, for example, memory 206, or a cache, such as found in an interface and memory controller hub that may be present in communications framework 202.

The illustrative embodiments herein provide a computer implemented method, a data processing system, and a computer program product for determining carrier selection based on variable volumetric weight and variable completion times. A product is identified for production. The product for production has a variable weight and a variable dimension based on components included in the product for production. A projected volumetric weight of the product for production is determined. A projected completion time of the product for production is determined. A projected carrier assignment of the product for production is then determined in response to determining the projected volumetric weight of the product for production and determining the projected completion time of the product for production.

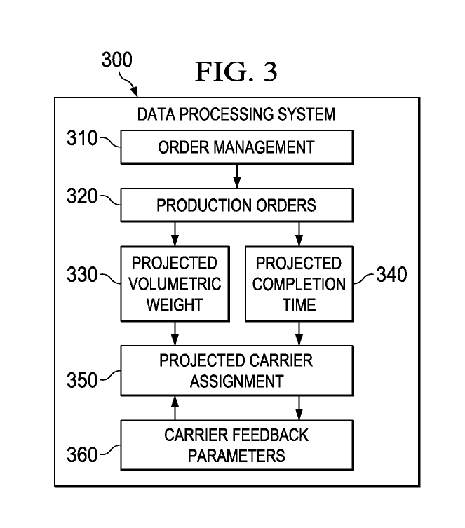

Referring now to FIG. 3, a high level data flow diagram for determining carrier selection based on variable volumetric weight and variable completion times is depicted in accordance with an illustrative embodiment. The data flow of FIG. 3 can be implemented in data processing system 300, which can be a data processing system, such as data processing system 200 of FIG. 2.

Data processing system 300 includes order management 310. Order management 310 is a software component for receiving and processing orders which can include new orders, alterations, and cancellations.

Data processing system 300 includes production orders 320. Production orders 320 is a software component that tracks products for production. Products tracked by production orders 320 have variable weights and dimensions based on the components that are included in those products. For example, production orders 320 can be a listing of build-to-order data processing systems, wherein the various data processing systems can be configured with different hardware and software components that affect the weight and dimensions of those data processing systems.

Data processing system 300 includes projected volumetric weight 330. Projected volumetric weight 330 is a software component that estimates a volumetric weight for products tracked by production orders 320. For example, projected volumetric weight 330 may estimate weights and packaged volume for data processing systems. The weights and packaged volume can include any packaging materials used in the shipping of the data processing systems.

Data processing system 300 includes projected completion time 340. Projected completion time 340 is a software component that estimates process completion times for variables configured to order products tracked by production orders 320. For example, projected completion time 340 may be a completion time for data processing systems.

Data processing system 300 includes projected carrier assignment 350. Projected carrier assignment 350 is a software component that predicts volumetric output per carrier and changes carrier assignments in real time to optimize carrier contracts and carrier capacity. Projected carrier assignment 350 compares actual carrier load to contracted load. Projected carrier assignment 350 forecasts aggregate output and is capable of periodically adjusting the forecast based on changes in production orders 320. Projected carrier assignment 350 is capable of aggregating shipping information for volumetric predictions for each contracted carrier. These predictions are periodically updated. The feed to each carrier is adjusted based on the updated predictions.

Data processing system 300 includes carrier feedback parameters 360. Carrier feedback parameters 360 is a software component that tracks carrier variables, such as, for example, but not limited to, contracted load, overage penalties, underage penalties, frozen zones, delivery statistics, and aggregated total load. The variables of carrier feedback parameters 360 are updated based on the carrier assignments made by projected carrier assignment 350. Additionally, carrier feedback parameters 360 provides input into projected carrier assignment 350 in order to optimize carrier assignments based on the variables tracked by carrier feedback parameters 360.

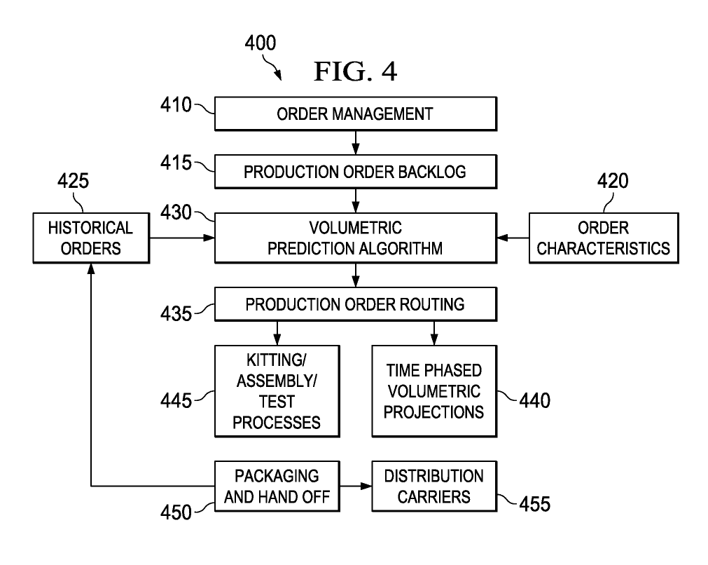

Referring now to FIG. 4, a data flow for predicting volumetric weight during supply chain order fulfillment is depicted in accordance with an illustrative embodiment. Data flow 400 is a software process executing in a software component, such as projected volumetric weight 330 of FIG. 3.

Order management 410 is order management 310 of FIG. 3. Production order backlog 415 is production orders 320 of FIG. 3. Order characteristics 420 are control characteristics for profiling packaging specifications in order to predict volumetric weight during supply chain order fulfillment. Order characteristics can include available packaging materials used for packaging certain orders within production order backlog 415 and associated characteristics. Order characteristics 420 can include the type of product ordered as indicated within production order backlog 415. Order characteristics 420 can include prediction horizons for order completion. Order characteristics 420 can include potential carriers that can be impacted by the orders within production order backlog 415. Order characteristics 420 can include a frequency of carrier predictions.

Historical orders 425 is a record of previous orders that have been shipped, including weights, volumes, and the packaging materials that were utilized in shipping those previous orders. Previous orders, along with the packaging materials used therewith, are initially used to train volumetric prediction algorithm 430 based on the packaging materials selected to ship the previous orders, as well as the actual weights of those previous orders.

Volumetric prediction algorithm 430 is a prediction analytic that is initiated on an order-by-order basis in real time. Volumetric prediction algorithm 430 determines a suggested packaging material and estimated gross weight for orders within production order backlog 415. Volumetric prediction algorithm 430 then uses the suggested packaging material and estimated gross weight to determine volumetric weight for orders within production order backlog 415.

Volumetric prediction algorithm 430 begins by partitioning orders within production order backlog 415 into units of work. Those units of work are subassemblies that can be later assimilated into the final product, such as a card assembly that can be incorporated into a rack system. The partitioned units of work include units of work that exist at the time of partitioning and those that do not exist until later in the production process.

For each unit of work, volumetric prediction algorithm 430 identifies the type of work and whether that type of work drives a need for packaging materials. A type of work can include, for example, but not limited to assembly of components into a rack assembly. A type of work drives a need for packaging materials if the type of work creates a separate package for shipping.

Volumetric prediction algorithm 430 further identifies the expected packaging material for orders within production order backlog 415. The expected packaging material can be determined based on the order characteristics, such as order characteristics 420. The characteristics used to identify the packaging material can be simple or complex. Simple characteristics include, but are not limited to, direct determinations of packaging material, such as where a rack type, work unit type, a specific order feature, a destination country, or combinations thereof always result in the same type of packaging material to be used. Complex characteristics include, but are not limited to, orders that include unassembled hardware, loose piece hardware, or combinations thereof where the packaging material is best determined at the point of packaging.

Volumetric prediction algorithm 430 further identifies whether the expected packaging material drives standard volumetric metrics. Certain packaging material has known volumetric measurements. Therefore, if the expected packaging material is associated with standard volumetric metrics, that particular order within production order backlog 415 can also be expected to have a corresponding standard volumetric metric.

For each order within production order backlog 415, volumetric prediction algorithm 430 then determines a summation of the volumetric content across all containers for the order. The summation of the volumetric content can then be used to determine a volumetric weight for each order within production order backlog 415.

Volumetric prediction algorithm 430 updates production order routing 435 with the projected volumetric weights for each order including the expected packaging material for orders within production order backlog 415. Production order routing 435 is a software system that provides direction in the packaging process including the selection of packaging materials.

Time phased volumetric projections 440 is a software component for providing a volumetric projection over a defined period of time. Volumetric output analysis of both production order backlog 415 and active orders listed in order management 410 can be listed. Taking into consideration new orders, changed orders, and changes to manufacturing cycle times, the time phased volumetric output provides an expected production volume within a given time period. The time phased volumetric output is used for directing carriers as to needed carrier capacity in the given time period.

Kitting/assembly/test processes 445 is a production process. Kitting/assembly/test processes 445 manufactures orders within production order backlog 415 according to any production analytics for the order.

Packaging and hand off 450 is a production process. Packaging and hand off 450 packages completed orders and transfers possession of the orders to distribution carriers 455 for delivery. Packaging and hand off 450 collects an actual weight for each order after packaging. The actual weights are then used to update historical orders 425.

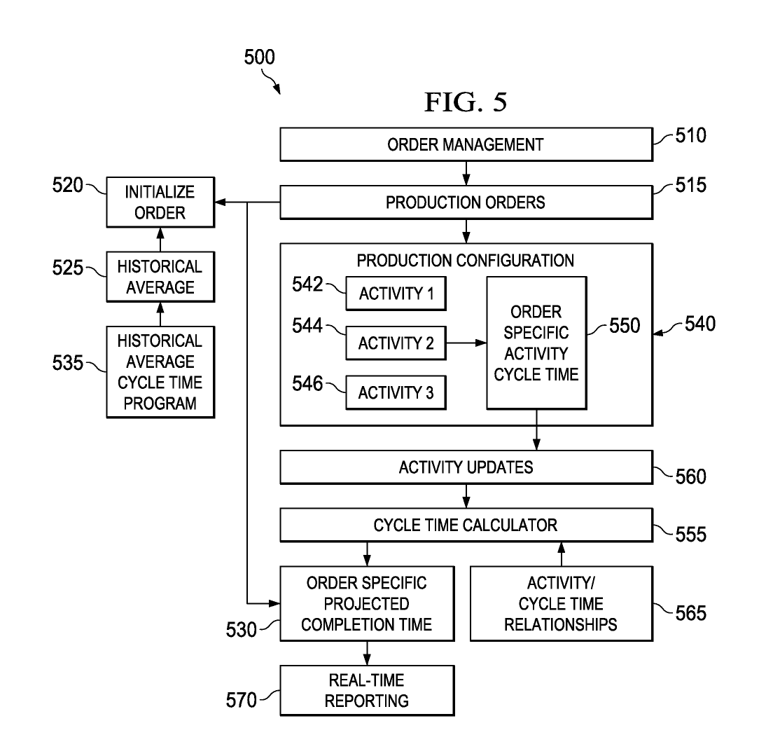

Referring now to FIG. 5, a data flow for predicting completion times during supply chain order fulfillment is depicted in accordance with an illustrative embodiment. Data flow 500 is a software process executing in a software component, such as projected completion time 340 of FIG. 3.

Order management 510 is order management 310 of FIG. 3. Production orders 515 is production orders 320 of FIG. 3. Initialize order 520 is a software process that applies historically based averages as an estimated production time. Initialize order 520 initially sets historical average 525 for the production time of production orders 515. Historical average 525 is an average cycle time, including any activity averages, for previous orders similar or identical to production orders 515. Historical average 525 initially determines order specific projected completion time 530. As activities are incrementally performed in production based on production orders 515, the historical averages can be replaced by actual cycle times for that incrementally performed activity. The historically based averages of historical average 525, initially applied by initialize order 520, are replaced by the actual cycle times for the incrementally performed activities. Order specific projected completion time 530 is then updated to reflect the actual cycle times for the incrementally performed activities instead of historical average 525. Historical average 525 is tracked and determined by historical average cycle time program 535.

Order specific projected completion time 530 is a software component that maintains per-order completion times as updated throughout the manufacturing process. As activities are incrementally performed in production based on production orders 515, the historical averages can be replaced by actual cycle times for that incrementally performed activity. The historically based averages of historical average 525, initially applied by initialize order 520, are replaced by the actual cycle times for the incrementally performed activities. Order specific projected completion time 530 is then updated to reflect the actual cycle times for the incrementally performed activities instead of historical average 525.

Production configuration 540 is a manufacturing process. Production configuration 540 is the manufacturing steps that production orders must go through in order to produce the configured product. Production configuration 540 subdivides the manufacturing process into a set of activities including, for example, activity 1 542, activity 2 544, and activity 3 546. Each of activity 1 542, activity 2 544, and activity 3 546 is an incremental quantized step in the manufacturing process. Each of activity 1 542, activity 2 544, and activity 3 546 is individually tracked on a per-order basis. Cycle times for each of activity 1 542, activity 2 544, and activity 3 546 is separately tracked in order specific activity cycle time 550. Order specific activity cycle time 550 is a software process that tracks quantized steps in the manufacturing process on a per-order basis.

Cycle time calculator 555 receives activity updates 560 from order specific activity cycle time 550 each time an activity in the manufacturing process is completed, such as one of activity 1 542, activity 2 544, and activity 3 546. Cycle time calculator 555 replaces historical average 525 of the completed activity with the actual cycle time for that activity. Cycle time calculator 555 then applies product activity rules retrieved from activity/cycle time relationships 565 to adjust order specific projected completion time 530 to reflect the actual cycle time for that activity.

At any time in the process, an operator can ascertain the predicting completion time of production orders 515 through real-time reporting 570. Real-time reporting 570 is a software component that is capable of communicating order specific projected completion time 530 to an operator or to other process control and analytical systems.

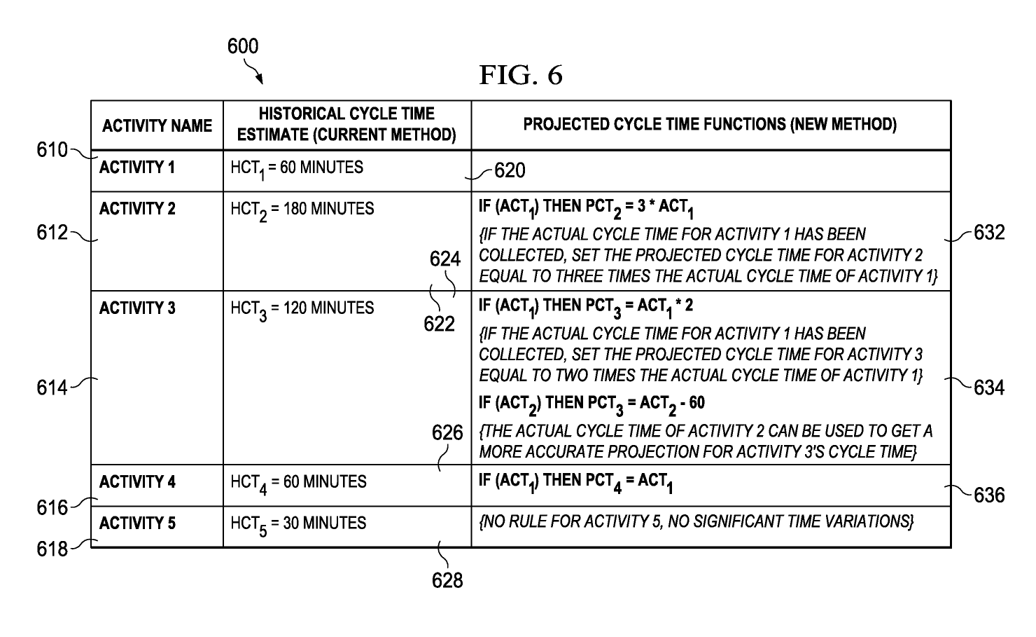

Referring now to FIG. 6, an exemplary activity/cycle time relationship table is depicted in accordance with an illustrative embodiment. Exemplary activity/cycle time relationship table 600 can be activity/cycle time relationships 565 of FIG. 5. The projected cycle time functions illustrated in exemplary activity/cycle time relationship table 600 are provided as only one example of possible projected cycle time functions that can be used to estimate activity completion times.

Each of activity 1 610, activity 2 612, activity 3 614, activity 4 616 and activity 618 is one of a set of activities, such as one of activity 1 542, activity 2 544, and activity 3 546 of FIG. 5. Each of activity 1 610, activity 2 612, activity 3 614, activity 4 616 and activity 5 618 is associated with a historical cycle time estimate. The historical cycle time estimate is an average cycle time, such as average cycle time 525, determined from historical average cycle time program 535 of FIG. 5. Activity 1 610 is associated with historical cycle time 1 620. Activity 2 612 is associated with historical cycle time 2 622. Activity 3 614 is associated with historical cycle time 3 624. Activity 4 616 is associated with historical cycle time 4 626. Activity 5 618 is associated with historical cycle time 5 628.

In addition to the historical cycle time estimate, each of activity 1 610, activity 2 612, activity 3 614, activity 4 616, and activity 5 618 is associated with a projected cycle time function. The projected cycle time function is an analytic that projects cycle time for an activity based on the cycle time of at least one previous activity, if that previous activity has been performed.

Projected cycle time function 2 632 is associated with activity 2 612. Projected cycle time function 2 632 projects cycle time for activity 2 612 based on the actual cycle time for activity 1 610. If activity 1 610 has not yet been performed, then historical cycle time 2 622 is used as an estimate of the cycle time for activity 2 612. However, if activity 1 610 has been performed, the actual cycle time for activity 1 610 is used to project the cycle time for activity 2 612 according to projected cycle time function 2 632.

Projected cycle time function 3 634 is associated with activity 3 614. Projected cycle time function 3 634 projects cycle time for activity 3 614 based on either the actual cycle time for activity 1 610 or the actual cycle time for activity 2 612. If activity 1 610 has not yet been performed, then historical cycle time 3 624 is used as an estimate of the cycle time for activity 3 614. If activity 1 610 has been performed but activity 2 612 has not yet been performed, the actual cycle time for activity 1 610 is used to project the cycle time for activity 3 614 according to projected cycle time function 3 634. If activity 2 612 has been performed, the actual cycle time for activity 2 612 is used to project the cycle time for activity 3 614 according to projected cycle time function 3 634.

Projected cycle time function 4 636 is associated with activity 4 616. Projected cycle time function 4 636 projects cycle time for activity 4 616 based on the actual cycle time for activity 1 610. If activity 1 610 has not yet been performed, then historical cycle time 4 626 is used as an estimate of the cycle time for activity 4 616. However, if activity 1 610 has been performed, the actual cycle time for activity 1 610 is used to project the cycle time for activity 4 616 according to projected cycle time function 4 636.

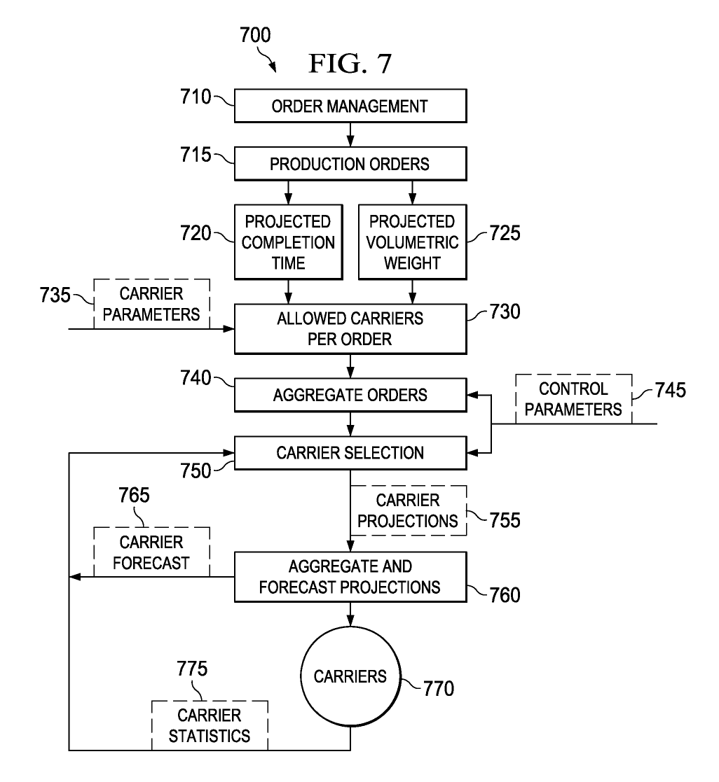

Referring now to FIG. 7, a data flow diagram for determining carrier selection based on variable volumetric weight and variable completion times is depicted in accordance with an illustrative embodiment. Data flow 700 is a software process executing in a software component, such as projected carrier assignment 350 of FIG. 3.

Order management 710 is order management 310 of FIG. 3. Production orders 715 is production orders 320 of FIG. 3. Projected completion time 720 is projected completion time 340 of FIG. 3. Projected volumetric weight 725 is projected volumetric weight 330 of FIG. 3.

Allowed carriers per order 730 is a software component that determines allowed carriers based on projected completion time 720, projected volumetric weight 725, and carrier parameters 735. Carrier parameters 735 are carrier variables, such as, for example, but not limited to, contracted load, overage penalties, underage penalties, frozen zones, shipping lanes, delivery statistics, and aggregated total load. Carrier parameters 735 are updated based on the carrier assignments made on a per order basis. Additionally, carrier parameters 735 provide input into allowed carriers per order 730 in order to optimize carrier assignments. Carrier parameters 735 can be tracked within a software component, such as carrier feedback parameters 360 of FIG. 3.

Aggregate orders 740 is a software process that aggregates orders based on a defined output period. The output period can be, for example, a time between scheduled order pickups by carriers. Aggregate orders 740 tracks which production orders are scheduled for completion during the defined output period, as well as the volumetric load projection for each of those orders.

Control parameters 745 is a set of rules used to determine which of a plurality of different carrier orders of production orders 715 should be assigned to. In one illustrative embodiment, control parameters 745 can include a plurality of carrier selection rules. These carrier selection rules provide an analytic for selecting a carrier based on, for example, but not limited to, contracted load, overage penalties, underage penalties, frozen zones, delivery statistics, and aggregated total load.

Carrier selection 750 is a software component that determines carrier projections 755. Carrier selection 750 utilizes aggregate orders 740 and control parameters 745 as well as carrier forecast 765 and carrier statistics 775 in order to project which carrier should be utilized for distribution of the product.

Aggregate and forecast projections 760 is a software component that determines carrier forecast 765. Aggregate and forecast projections 760 aggregates carrier projections 755 for each of production orders 715 and forecasts the aggregated carrier projections to carriers 770 via carrier forecast 765. Carrier forecast 765 further provides a feedback process into carrier selection 750 so that production orders 715 can be further optimized among the various carriers. Carriers 770 can utilize carrier forecast 765 from aggregate and forecast projections 760 to better determine a number of trucks or other distribution resources that should be allocated for distribution of the products during the output period.

Carrier statistics 775 are distribution statistics for each of carriers 770. Carrier statistics 775 can be, for example, but not limited to, historical volumetric weight shipped per carrier, volumetric weight assigned to be shipped per carrier, and carrier forecast within a given time period. Carrier statistics 775 further provides a process feedback into carrier selection 750 so that production orders 715 can be further optimized among the various carriers.

In one illustrative embodiment, orders for products within production orders 715 are periodically repitched based on a production basis and an exception basis. This repitching is a self-adjusting reprioritization of the order backlog on an exception basis. Repitching of production orders 715 results in every order's carrier assignment being re-evaluated if the product is not within a forecast frozen zone for the product.

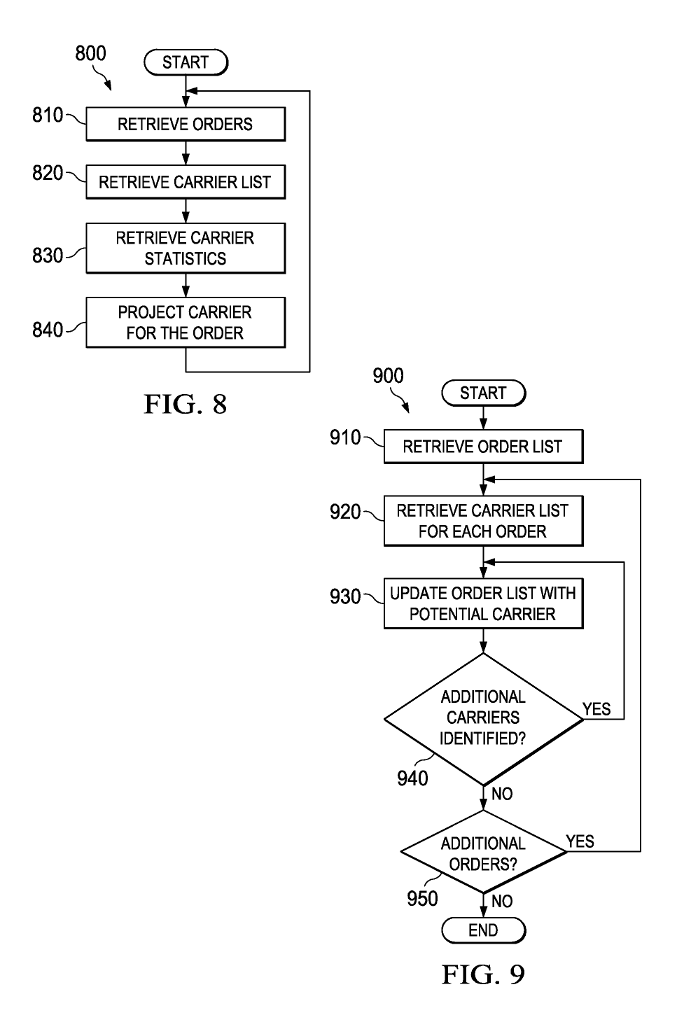

Referring now to FIG. 8, a high level flow chart for determining carrier selection based on variable volumetric weight and variable completion times is depicted in accordance with an illustrative embodiment. Process 800 is a software process executed in one or more software components, such as allowed carriers per order 730, aggregate orders 740, carrier selection 750, and aggregate and forecast projections 760.

Process 800 begins by retrieving orders (step 810). The orders have variable weights and dimensions based on the components that are included in those products. For example, an order can be a build-to-order data processing system, wherein the various data processing systems can be configured with different hardware and software components that affect the volumetric load of those data processing systems. The orders can be retrieved from a software component that tracks products for production, such as production orders 320 of FIG. 3.

Responsive to retrieving the orders, process 800 retrieves a carrier list for each order (step 820). The carrier list can be retrieved, for example, from allowed carriers per order 730 of FIG. 7. In one illustrative embodiment, the carrier list can be determined based on carrier parameters, such as carrier parameters 735 of FIG. 7. The carrier parameters can be, for example, but not limited to, contracted load, overage penalties, underage penalties, frozen zones, shipping lanes, delivery statistics, and aggregated total load.

Responsive to retrieving the carrier list, process 800 retrieves carrier statistics (step 830). Carrier statistics are carrier statistics 775 of FIG. 7. Carrier statistics can include, but are not limited to, historical volumetric weight shipped per carrier, volumetric weight assigned to be shipped per carrier, and carrier forecast within a given time period.

Responsive to retrieving the carrier list, process 800 projects a carrier for the order (step 840). The carrier projection can be determined by a software component, such as carrier selection 750 of FIG. 7. The projected carrier for the order utilizes aggregate orders 740 and control parameters 745, as well as carrier forecast 765 and carrier statistics 775 of FIG. 7 in order to project which carrier should be utilized for distribution of the product. Process 800 then iterates back to step 810 to retrieve additional orders and also to re-project carriers based on those additional orders.

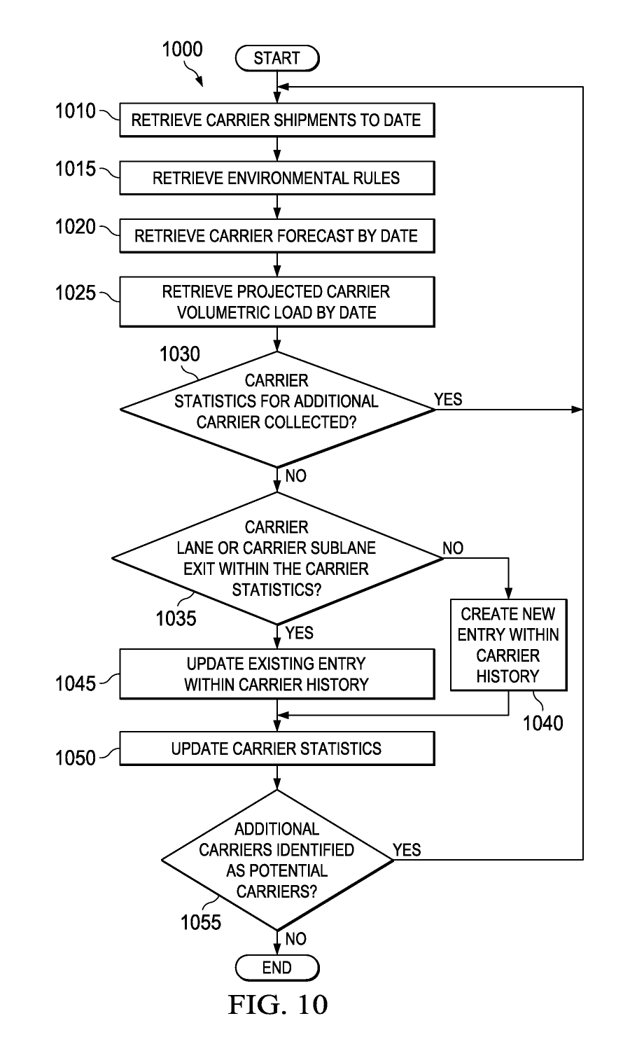

Referring now to FIG. 9, a flowchart for retrieving a carrier list is depicted in accordance with an illustrative embodiment. Process 900 is a more detailed description of step 820 of FIG. 8. Process 900 begins by retrieving an order list (step 910). For each order in the order list, process 900 retrieves a carrier list (step 920). The carrier list can be retrieved based on carrier parameters 735 of FIG. 7. The carrier list is retrieved on a per-order basis. The carrier list lists potential carriers based on, for example, but not limited to, country code or region that the order should be distributed to, active and effective carrier contracts, and maximum package weights that can be handled by a particular carrier. The carrier list can be generated by a software process, such as allowed carriers per order 730 of FIG. 7. Process 900 then updates the order list with a potential carrier identified in the carrier list (step 930).

Process 900 then determines whether additional carriers are identified on the carrier list (step 940). If additional carriers are identified (“yes” at step 940), process 900 iterates back to step 930 to update the order list with the additional potential carriers. If additional carriers are not identified on the carrier list (“no” at step 940), process 900 determines if there are any additional orders in the order list (step 950). If additional orders are in the order list (“yes” at step 950), process 900 iterates back to step 920 to retrieve a carrier list for that order. If additional orders are not in the order list (“no” at step 950), process 900 terminates.

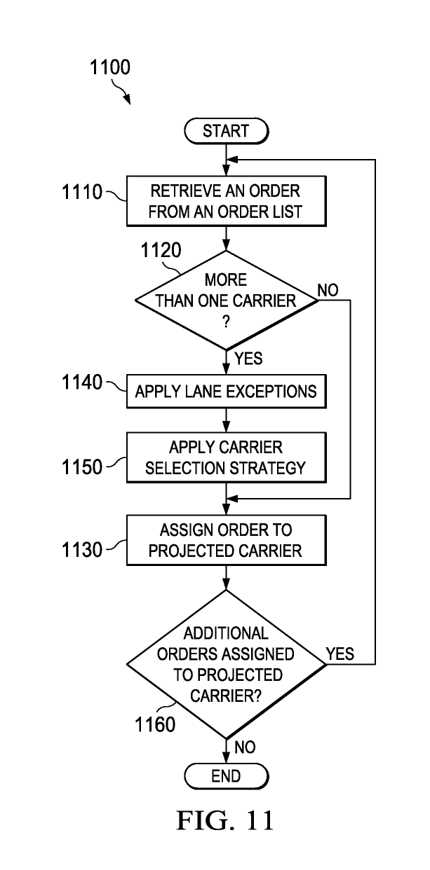

Referring now to FIG. 10, a flowchart for retrieving carrier statistics is depicted in accordance with an illustrative embodiment. Process 1000 is a more detailed description of step 830 of FIG. 8. When at least one potential carrier has been identified, process 1000 begins by retrieving carrier shipments to date (step 1010). Carrier shipments to date is a record of all shipments that have been made including volumetric loads thereof utilizing a particular carrier. Carrier shipments to date can be retrieved, for example, from a record of previous orders that have been shipped including weights, volumes, and the packaging materials that were utilized in shipping those previous orders, such as historical orders 425 of FIG. 4.

Responsive to retrieving carrier shipments to date, process 1000 retrieves any applicable environmental rules (step 1015). The environmental rules are carrier timeliness, carrier reliability, frozen zone, carrier reference strategy, priority, carrier split, volumetric contract amounts, forecast overage and underage tolerances, and lane maximum. Responsive to retrieving any environmental rules, process 1000 retrieves the carrier forecast by date (step 1020). The carrier forecast by date is the forecasted orders that will be shipped via a particular carrier on a particular date. Process 1000 also retrieves the projected carrier volumetric load by date (step 1025). The projected carrier volumetric load is the forecasted volumetric load for orders that will be shipped via a particular carrier on a particular date.

Process 1000 then determines if carrier statistics for any additional carrier should be collected (step 1030). Carrier statistics for any additional carrier should be collected when more than one potential carrier has been identified by process 900 of FIG. 9. If carrier statistics for any additional carrier are collected (“yes” at step 1030), then process 1000 iterates back to step 1010 to retrieve carrier shipments to date, applicable environmental rules, carrier forecast and projected carrier volumetric load for the additional carriers. If carrier statistics for any additional carrier are not collected (“no” at step 1030), then process 1000 continues to step 1035 and process 1000 determines whether a carrier lane or carrier sublane exists within the carrier statistics. The result provides a detailed listing of volumetric weight assigned to a carrier for a given period. Responsive to determining that a carrier lane or carrier sublane does not exist within the carrier statistics (“no” at step 1035), process 1000 creates a new entry within the carrier history (step 1040). Responsive to determining that a carrier lane or carrier sublane does exist within the carrier statistics (“yes” at step 1035), process 1000 updates the existing entry within the carrier history (step 1045).

Process 1000 then updates the carrier statistics (step 1050). The carrier statistics can be, for example, carrier statistics 775 of FIG. 7. Responsive to updating the carrier statistics, process 1000 determines if there are any additional carriers identified as potential carriers (step 1055). Responsive to determining that additional carriers are identified as potential carriers, process 1000 iterates back to step 1010 to retrieve carrier shipments for the additional potential carrier. Responsive to determining that no additional carriers are identified as potential carriers, process 1000 terminates.

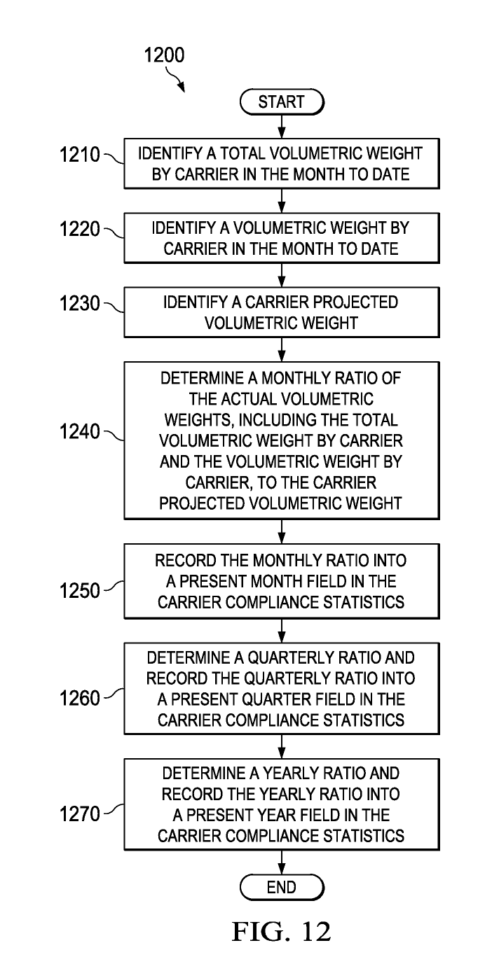

Referring now to FIG. 11, a flowchart for projecting a carrier for an order is depicted in accordance with an illustrative embodiment. Process 1100 is a more detailed description of step 840 of FIG. 8. Process 1100 begins by retrieving an order from an order list, the order list including potential carriers for the order (step 1110). The order list including potential carriers can be generated, for example, by software process 1000 of FIG. 10. Responsive to retrieving an order from an order list, process 1100 determines if there is more than one potential carrier for the order (step 1120). If there is only one potential carrier (“no” at step 1120), process 1100 assigns the order to the projected carrier (step 1130). Because there is only one potential carrier, the order must be dispatched to that particular carrier.

However, if process 1100 determines that there is more than one potential carrier for the order (“yes” at step 1120), process 1100 performs a carrier optimization in order to determine a projected carrier for the order. The carrier optimization begins by applying any lane exceptions for the order (step 1140). Lane exceptions are limitations imposed by particular carriers on the orders dispatched to that particular carrier. These limitations can be physical limitations, such as volumetric load limits, maximum load per lane, and maximum number of packages or contracted limitations, such as forecast tolerances and specific exclusions of particular orders. The lane exceptions are used to eliminate potential carriers that are unable to take delivery of the order, either due to physical or contracted limitations despite having a corresponding shipping lane.

After lane exceptions are applied, process 1100 applies a carrier selection strategy (step 1150). The carrier selection strategy is an analytic that selects a particular carrier from the potential carriers based on selection criteria, for example, but not limited to, carrier preference priority, carrier compliance percentages, and specific carrier exclusions. Responsive to applying the carrier selection strategy, process 1100 assigns the order to the projected carrier (step 1130). Here, the order is assigned to the projected carrier based on the carrier selection strategy applied in step 1150. Process 1100 then determines if there are additional orders that should be assigned to a projected carrier (step 1160). If there are additional orders that should be assigned to a projected carrier (“yes” at step 1160), process 1100 iterates back to step 1110 to retrieve an order from an order list. If there are no additional orders that should be assigned to a projected carrier (“no” at step 1160), process 1100 terminates.

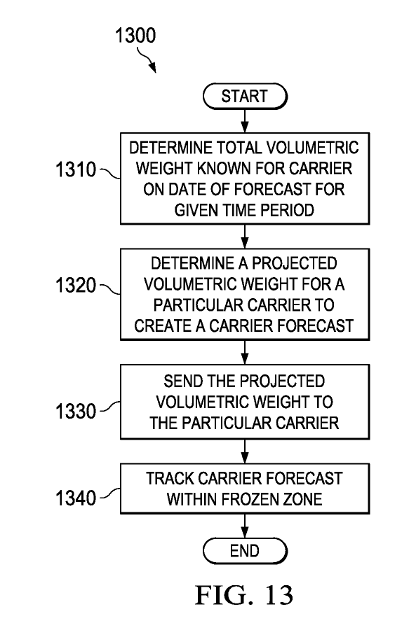

Referring now to FIG. 12, a flowchart of a process for determining carrier compliance statistics is depicted in accordance with an illustrative embodiment. Process 1200 is a software process for determining carrier parameters, such as carrier parameters 735 of FIG. 7. Process 1200 is a software process executing on a software component, such as carrier feedback parameters 360 of FIG. 3.

Process 1200 begins by identifying a total volumetric weight by carrier in the month to date (step 1210). The history for the total volumetric weight by carrier in the month to date is a record of the total volumetric weight delivered by a particular carrier in previous years during the present month. For example, if the present date is in the month of September, process 1200 will read a history for the total volumetric weight by carrier in previous years for the month of September. Next, process 1200 identifies a volumetric weight by carrier in the month to date (step 1220). Process 1200 then identifies a carrier projected volumetric weight (step 1230). The carrier projected volumetric weight is a record of a projection of the total volumetric weight to be delivered by a particular carrier in previous years during the present month. The forecast is generated based on the historic skew and current order load.

Responsive to identifying the total volumetric weight by carrier, the volumetric weight by carrier, and the projected volumetric weight, process 1200 determines a monthly ratio of the actual volumetric weights including the total volumetric weight by carrier and the volumetric weight by carrier to the carrier projected volumetric weight (step 1240). Process 1200 then records the monthly ratio into a present month field in the carrier compliance statistics (step 1250). Process 1200 then determines a quarterly ratio, recording the quarterly ratio into a present quarter field in the carrier compliance statistics (step 1260). Determination of the quarterly ratio is performed similar to the determination of the monthly ratio, but instead uses the total volumetric weight by carrier, the volumetric weight by carrier, and the projected volumetric weight for historical quarterly periods instead of monthly periods.

Process 1200 then determines a yearly ratio, recording the yearly ratio into a present year field in the carrier compliance statistics (step 1270), with the process terminating thereafter. Determination of the yearly ratio is performed similar to the determination of the monthly ratio but instead uses the total volumetric weight by carrier, the volumetric weight by carrier, and the projected volumetric weight for historical yearly periods instead of monthly periods.

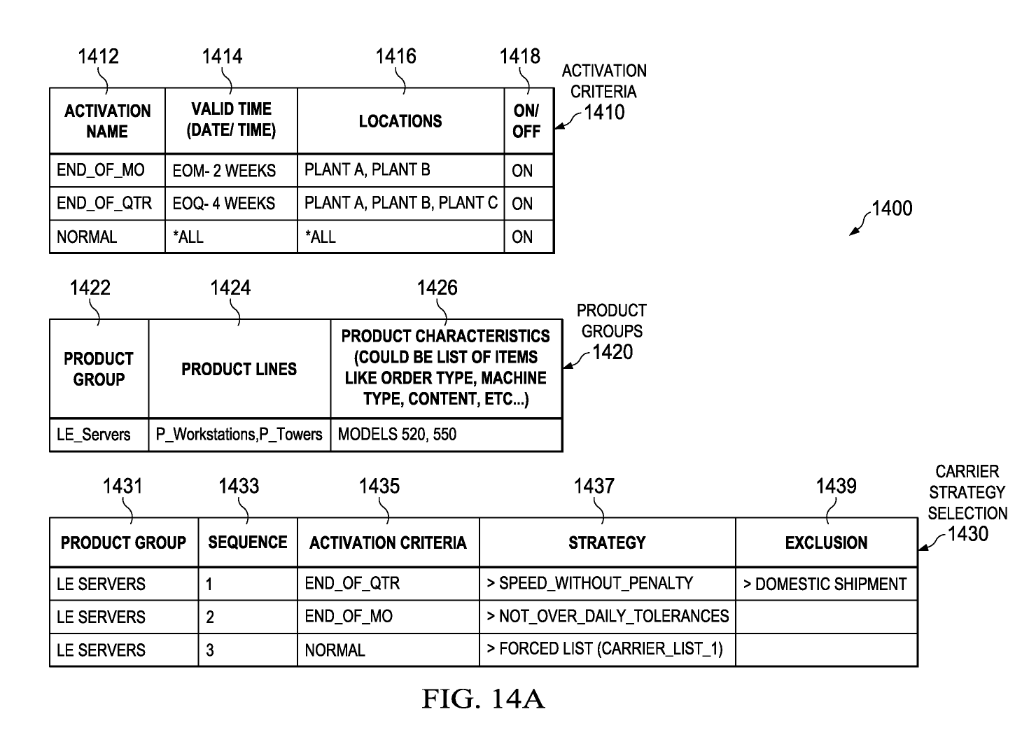

Referring now to FIG. 13, a flowchart of a process for sending carrier forecasts to projected carriers is depicted in accordance with an illustrative embodiment. Process 1300 is a software process, executing on a software component, such as aggregate and forecast projections 760 of FIG. 7. Process 1300 begins by determining a total volumetric weight known for a particular carrier on a date of the forecast for a given time period (step 1310). The given time period can be, for example, a day, a month, a quarter, or a year. The total volumetric weight known is determined by a software process, such as process 1200 of FIG. 12.

Process 1300 then determines a projected volumetric weight for a particular carrier to create a carrier forecast (step 1320). The projected volumetric weight can be determined, for example, by applying a monthly ratio, a quarterly ratio, or a yearly ratio, as determined in steps 1250, 1260, and 1270 of FIG. 12 to the total volumetric weight known for a particular carrier on a date of the forecast for a given time period. The carrier forecast can be, for example, carrier forecast 765 of FIG. 7. Process 1300 then sends the projected volumetric weight to the particular carrier (step 1330). Carriers, such as carriers 770 of FIG. 7, can utilize the projected volumetric weight to better determine a number of trucks or other distribution resources that should be allocated for distribution of the products during the output period.

Process 1300 tracks the carrier forecast within a frozen zone (step 1340) with the process terminating thereafter. A frozen zone is a time period proximate to a scheduled ship date during which trucks or other distribution resources have been allocated by a particular carrier. During a frozen zone, additional penalties and fees are typically applied to significant changes in projected orders and volumetric loads. By minimizing changes in projected orders and volumetric loads during the frozen zone, additional penalties and fees can be avoided. By tracking the carrier forecast within a frozen zone, process 1300 can avoid reallocating orders to other carriers that would significantly change projected orders and volumetric loads for a particular carrier and therefore result in additional penalties and fees.

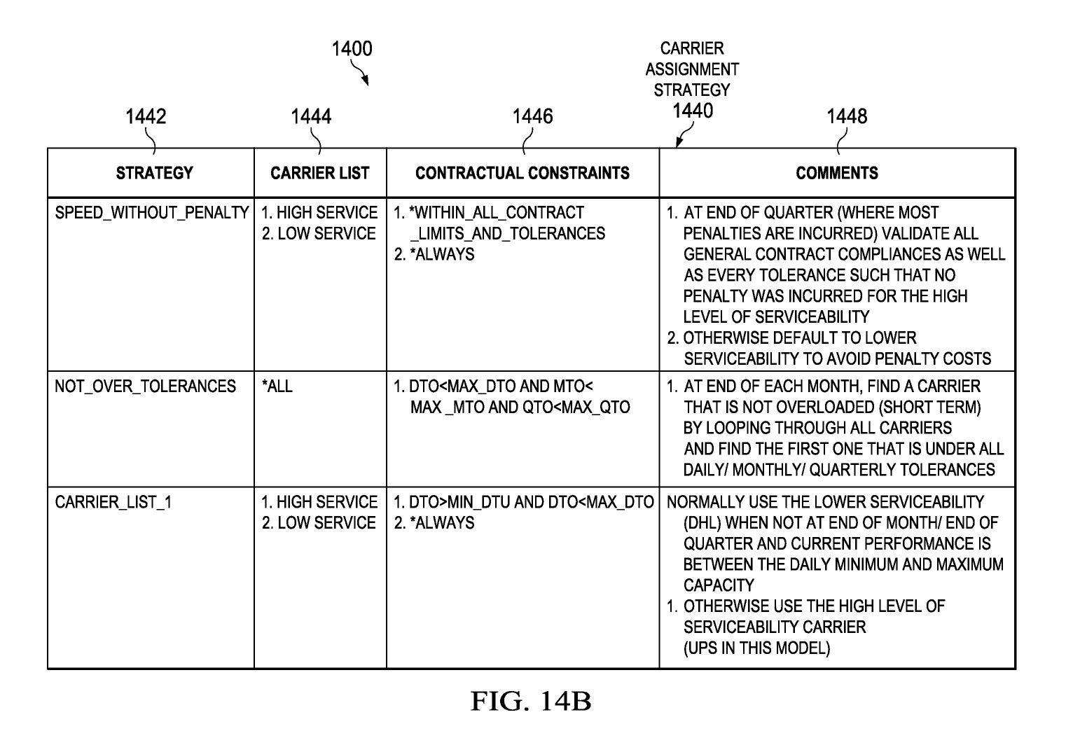

Referring now to FIGS. 14A-14B, a carrier assignment strategy is depicted in accordance with an illustrative embodiment. The carrier assignment strategy is an analytic that selects a particular carrier from the potential carriers based on selection criteria, for example, but not limited to, carrier preference priority, carrier compliance percentages, and specific carrier exclusions. The carrier assignment strategy is applied in assigning projected carriers, such as in step 1150 of FIG. 11.

Referring now specifically to FIG. 14A, carrier assignment strategy 1400 includes activation criteria 1410. Activation criteria 1410 are circumstances under which various ones of carrier assignment strategies 1412 should be implemented. Each activation criteria in activation criteria 1410 includes activation name 1412. Activation name 1412 is an identification of the various activation criteria in activation criteria 1410. Each activation criteria in activation criteria 1410 includes valid time 1414. Valid time 1414 is a time period during which particular activation criteria will be utilized. Each activation criteria in activation criteria 1410 includes locations 1416. Locations 1416 is a listing of various manufacturing locations at which a particular activation criteria is implemented. Each activation criteria in activation criteria 1410 includes flag 1418. Flag 1418 allows for various activation criteria to be toggled between an “on” state and an “off” state.

Carrier assignment strategy 1400 includes product groups 1420. Product groups 1420 are products to which carrier assignment strategy 1400 should be applied. Product groups 1420 includes product group 1422. Product group 1422 is an identification of the product groups in product groups 1420. Product groups 1420 includes product lines 1424 and product characteristics 1426. Both product lines 1424 and product characteristics 1426 are further descriptions of the associated ones of product group 1422.

Carrier assignment strategy 1400 includes carrier strategy selection 1430. Carrier strategy selection 1430 is an analytic that determines which of carrier assignment strategy 1440 should be applied. Carrier strategy selection 1430 includes product group 1431. Product group 1431 is product group 1422. Carrier strategy selection 1430 includes sequence 1433. Sequence 1433 is a hierarchical order in which various activation strategies should be employed. Carrier strategy selection 1430 includes activation criteria 1435. Activation criteria 1435 is activation criteria 1410. Carrier strategy selection 1430 includes carrier activation strategy 1437. Carrier activation strategy 1437 is carrier assignment strategy 1440. Carrier strategy selection 1430 includes exclusion 1439. Exclusion 1439 is at least one circumstance or condition under which carrier activation strategy 1437 should not be applied despite the occurrence of activation criteria 1435.

Referring now specifically to FIG. 14B, carrier assignment strategy 1440 includes carrier assignment strategy 1440. Carrier assignment strategy 1440 describes conditions under which one potential carrier should be preferentially selected over another potential carrier. Carrier assignment strategy 1440 includes strategies 1442. Strategies 1442 is an identification of the various carrier assignment strategies in carrier assignment strategy 1440. Carrier assignment strategy 1440 includes carrier list 1444. Carrier list 1444 is an indication of various carriers that can be used when operating under a particular one of carrier assignment strategy 1440. Carrier assignment strategy 1440 includes contractual constraints 1446. Contractual constraints 1446 are contractual conditions under which certain carriers of carrier list 1444 should be utilized. Carrier assignment strategy 1440 includes comments 1448. Comments 1448 is a textual description of any pseudo code listed in contractual constraints 1446.

Thus, the illustrative embodiments herein provide a computer implemented method, a data processing system, and a computer program product for determining carrier selection based on variable volumetric weight and variable completion times. A product is identified for production. The product for production has a variable weight and a variable dimension based on components included in the product for production. A projected volumetric weight of the product for production is determined. A projected completion time of the product for production is determined. A projected carrier assignment of the product for production is then determined in response to determining the projected volumetric weight of the product for production and determining the projected completion time of the product for production.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer implemented method for determining a projected carrier assignment for a product for production, the computer implemented method comprising:
identifying the product for production, wherein the product for production has a variable weight and a variable dimension based on components included in the product for production;
determining a projected volumetric weight of the product for production;
determining a projected completion time of the product for production; and
responsive to determining the projected volumetric weight of the product for production and determining the projected completion time of the product for production, determining the projected carrier assignment of the product for production.

2. The computer implemented method of claim 1, wherein the step of determining the projected volumetric weight further comprises:
determining a suggested packaging material for the product for production, wherein determining the suggested packaging material comprises identifying at least one of simple characteristics of the suggested packaging material and complex characteristics of the suggested packaging material;
responsive to determining the suggested packaging material, determining whether the suggested packaging material drives standard volumetric metrics; and
determining an estimated gross weight for the product for production.

3. The computer implemented method of claim 1, wherein the step of determining the projected completion time further comprises:
identifying a historical average for the product for production, wherein the historical average is an average cycle time for at least one previous order for a product that is similar to the product for production or identical to the product for production.

4. The computer implemented method of claim 3 further comprising:
incrementally replacing the historical average for activities within the historical average for the product for production with actual cycle times of the activities of the product for production as one of the activities are incrementally performed.

5. The computer implemented method of claim 1, wherein the step of determining the projected carrier assignment further comprises:
determining the projected carrier assignment of the product for production based on carrier parameters, wherein the carrier parameters include a contracted load for a group of carriers, overage penalties for the group of carriers, underage penalties for the group of carriers, frozen zones for the group of carriers, shipping lanes for the group of carriers, delivery compliance statistics for the group of carriers, and aggregated total load for the group of carriers.

6. The computer implemented method of claim 5, wherein the carrier parameters are updated based on the projected carrier assignment made on a per order basis.

7. The computer implemented method of claim 1, wherein the step of determining the projected carrier assignment further comprises:
determining a number of potential carriers for the product for production;
responsive to determining that the number of potential carriers for the product for production is greater than one, applying a lane exception and a carrier selection strategy to determine the projected carrier assignment from the number of potential carriers; and
periodically repitching the order backlog on an exception basis, wherein the adjusting is a self adjusting process resulting in every order's carrier assignment being re-evaluated if the product is not within a forecast frozen zone for the product.

8. The computer implemented method of claim 7, wherein the step of determining the projected carrier assignment further comprises determining carrier compliance statistics for the number of potential carriers, the step of determining the carrier compliance statistics for the number of potential carriers further comprising:
identifying a total volumetric weight by carrier to date;
identifying a carrier projected volumetric weight, wherein the carrier projected volumetric weight is a record of a projection of the total volumetric weight to be delivered by a particular carrier in previous years during a time period; and
determining a time period ratio of actual volumetric weights including the total volumetric weight by carrier and the carrier projected volumetric weight.

9. The computer implemented method of claim 1, wherein the product for production is a first product for production, the computer implemented method further comprising:
identifying a second product for production, wherein the second product for production has a variable weight and a variable dimension based on components included in the second product for production;
determining a projected volumetric weight of the second product for production;
determining a projected completion time of the second product for production;
determining a number of potential carriers for the second product for production responsive to determining that the number of potential carriers for the second product for production is greater than one, applying a lane exception and a carrier selection strategy to determine a projected carrier assignment for the second product for production from the number of potential carriers; and
responsive to determining the projected volumetric weight of the second product for production and determining the projected completion time of the second product for production and responsive to the projected carrier for the first product for production.

10. A computer storage medium having computer usable instructions for determining a projected carrier assignment for a product for production encoded thereon, the computer storage medium comprising:
instructions for identifying the product for production, wherein the product for production has a variable weight and a variable dimension based on components included in the product for production;
instructions for determining a projected volumetric weight of the product for production;
instructions for determining a projected completion time of the product for production; and
instructions, responsive to determining the projected volumetric weight of the product for production and determining the projected completion time of the product for production, for determining a projected carrier assignment of the product for production.

11. The computer storage medium of claim 10, wherein the instructions for determining the projected volumetric weight further comprises:
instructions for determining a suggested packaging material for the product for production, wherein determining the suggested packaging material comprises identifying at least one of simple characteristics of the suggested packaging material and complex characteristics of the suggested packaging material;
instructions, responsive to determining the suggested packaging material, for determining whether the suggested packaging material drives standard volumetric metrics; and
instructions for determining an estimated gross weight for the product for production.

12. The computer storage medium of claim 10, wherein the instructions for determining the projected completion time further comprises:
instructions for identifying a historical average for the product for production, wherein the historical average is an average cycle time for at least one previous order for a product that is similar to the product for production or identical to the product for production.

13. The computer storage medium of claim 12 further comprising:
instructions for incrementally replacing the historical average for activities within the historical average for the product for production with actual cycle times of the activities of the product for production as ones of the activities are incrementally performed.

14. The computer storage medium of claim 10, wherein the instructions for determining the projected carrier assignment further comprises:
instructions for determining the projected carrier assignment of the product for production based on carrier parameters, wherein the carrier parameters include a contracted load for a group of carriers, overage penalties for the group of carriers, underage penalties for the group of carriers, frozen zones for the group of carriers, shipping lanes for the group of carriers, delivery compliance statistics for the group of carriers, and aggregated total load for the group of carriers.

15. The computer storage medium of claim 14, wherein the carrier parameters are updated based on the projected carrier assignment made on a per order basis.

16. The computer storage medium of claim 10, wherein the instructions for determining the projected carrier assignment further comprises:
instructions for determining a number of potential carriers for the product for production;
instructions, responsive to determining that the number of potential carriers for the product for production is greater than one, for applying a lane exception and a carrier selection strategy to determine the projected carrier assignment from the number of potential carriers; and
instructions for periodically repitching the order backlog on an exception basis, wherein the adjusting is a self adjusting process resulting in every order's carrier assignment being re-evaluated if the product is not within a forecast frozen zone for the product.

17. The computer storage medium of claim 16, wherein the instructions for determining the projected carrier assignment further comprises instructions for determining carrier compliance statistics for the number of potential carriers, instructions for determining the carrier compliance statistics for the number of potential carriers further comprising:
instructions for identifying a total volumetric weight by carrier to date;
instructions for identifying a carrier projected volumetric weight, wherein the carrier projected volumetric weight is a record of a projection of the total volumetric weight to be delivered by a particular carrier in previous years during a time period; and
instructions for determining a time period ratio of actual volumetric weights including the total volumetric weight by carrier and the carrier projected volumetric weight.

18. A data processing system comprising:
a storage having computer usable instructions for determining a projected carrier assignment for a product for production encoded thereon:
a bus connecting the storage to a processor; and
a processor, wherein the processor executes the computer usable instructions: to identify the product for production, wherein the product for production has a variable weight and a variable dimension based on components included in the product for production; to determine a projected volumetric weight of the product for production; to determine a projected completion time of the product for production; and responsive to determining the projected volumetric weight of the product for production and determining the projected completion time of the product for production to determine a projected carrier assignment of the product for production.

19. The data processing system of claim 18, wherein the processor executing the computer usable instructions to determine the projected volumetric weight further comprises the processor executing the computer usable instructions:
to determine a suggested packaging material for the product for production, wherein determining the suggested packaging material comprises identifying at least one of simple characteristics of the suggested packaging material and complex characteristics of the suggested packaging material; responsive to determining the suggested packaging material, to determine whether the suggested packaging material drives standard volumetric metrics; and to determine an estimated gross weight for the product for production.

20. The data processing system of claim 18, wherein the processor executing the computer usable instructions to determine the projected completion time further comprises the processor executing the computer usable instructions:
to identify a historical average for the product for production, wherein the historical average is an average cycle time for at least one previous order for a product that is similar to the product for production or identical to the product for production.

21. The data processing system of claim 20, wherein the processor further executes the computer usable instructions:
to incrementally replace the historical average for activities within the historical average for the product for production with actual cycle times of the activities of the product for production as ones of the activities are incrementally performed.

22. The data processing system of claim 18, wherein the processor executing the computer usable instructions to determine the projected carrier assignment further comprises the processor executing the computer usable instructions:
to determine the projected carrier assignment of the product for production based on carrier parameters, wherein the carrier parameters include a contracted load for a group of carriers, overage penalties for the group of carriers, underage penalties for the group of carriers, frozen zones for the group of carriers, shipping lanes for the group of carriers, delivery compliance statistics for the group of carriers, and aggregated total load for the group of carriers.

23. The data processing system of claim 22, wherein the carrier parameters are updated based on the projected carrier assignment made on a per order basis.

24. The data processing system of claim 18, wherein the processor executing the computer usable instructions to determine the projected carrier assignment further comprises the processor executing the computer usable instructions:
to determine a number of potential carriers for the product for production;
responsive to determining that the number of potential carriers for the product for production is greater than one, to apply a lane exception and a carrier selection strategy to determine the projected carrier assignment from the number of potential carriers; and
to periodically repitch the order backlog on an exception basis, wherein the adjusting is a self adjusting process resulting in every order's carrier assignment being re-evaluated if the product is not within a forecast frozen zone for the product.

25. The data processing system of claim 24, wherein the processor executing the computer usable instructions to determine the projected carrier assignment further comprises the processor executing the computer usable instructions to determine carrier compliance statistics for the number of potential carriers, the processor executing the computer usable instructions to determine the carrier compliance statistics for the number of potential carriers further comprising the processor executing the computer usable instructions:
to identify a total volumetric weight by carrier to date;
to identify a carrier projected volumetric weight, wherein the carrier projected volumetric weight is a record of a projection of the total volumetric weight to be delivered by a particular carrier in previous years during a time period; and
to determine a time period ratio of actual volumetric weights including the total volumetric weight by carrier and the carrier projected volumetric weight.
